(19) United States
(12) Patent Application Publication
(10) Pub. No.: US 2009/0051462 A1
(43) Pub. Date: Feb. 26, 2009

(54) HF Coupler or HF Power Splitter, Especially a Narrow-Band and/or 3DB Coupler or Power Splitter

(75) Inventors: Franz Rottmoser, Schechen (DE); Joachim Herold, Flintsbach (DE)

Correspondence Address: NIXON & VANDERHYE, PC, 901 NORTH GLEBE ROAD, 11TH FLOOR, ARLINGTON, VA, 22203, US

(73) Assignee: Kathrein-Werke KG, Rosenheim (DE)

(21) Appl. No.: 11/887,933

(22) PCT Filed: Mar. 9, 2006
(86) PCT No.: PCT/EP2006/002189

§ 371 Date: Oct. 5, 2007

(30) Foreign Application Priority Data
Apr. 7, 2005 (DE) 10 2005 016 054.9

(51) Int. Cl. H01P 5/18

(52) U.S. Cl. 333/112

(57) ABSTRACT

An improved HF coupler or HF power splitter comprises four connection lines arranged on the same side of the substrate. Two coupling zones are formed on the substrate on two opposite sides; the second coupling zone is connected to the associated connection lines arranged on the side of the substrate opposing the coupling zone, by means of two via holes in an electroplated manner. The capacitors provided at the beginning and at each end of each coupling zone are respectively embodied as interdigital capacitors; and the capacitors are respectively coupled to earth.

### CROSS-REFERENCES TO RELATED APPLICATIONS

This application is the U.S. national phase of International Application No. PCT/EP2006/002189, filed 9 Mar. 2006, which designated the U.S. and claims priority to German Patent Application No. 10 2005 016 054.9, filed 7 Apr. 2005, the entire contents of each of which are hereby incorporated by reference.

### FIELD

The technology herein relates to an HF coupler or HF power splitter, especially a narrow-band HF coupler or HF power splitter.

### BACKGROUND AND SUMMARY

In high-frequency technical systems it is often necessary for a signal, for example with a power P, to be split into two signals with a power of P/2 each. To do this, ring couplers are frequently used. Such ring couplers are known, for example, from Zinke Brunswig, “High-frequency Technology”, Springer-Verlag, 6^{th} Edition, 2000, and specifically page 192.

These ring couplers are frequently designed in microstrip conductor technology.

In addition to this, however, high-frequency couplers are also known with which the earth of the coupling is, as a rule, adjusted by way of lines coupled via the face side or the longitudinal side.

For higher degrees of coupling, such as are needed for a power splitter, these distance intervals are often very small or even too small to be capable of being manufactured economically.

Thus, for example, a directional coupler is also known from EP 1 291 959 A1, which is based, for example, on suspended-substrate technology. In other words, a coupling zone in stripline technology is provided on a substrate on the one side, which is in connection with two, first and second, connections on the substrate, likewise designed in stripline technology. A second coupling zone is then arranged on the opposite side, which leads to a third and fourth output or connection. In a plan view, the two coupling zones are arranged at least partially overlapping.

According to the previous publication referred to heretofore, EP 1 291 959 A1, it is also possible for capacitors to be connected to the two opposed ends of the two coupling zones in each case, the second connection point of which is in each case in contact with an earth.

From the same previous publication, however, other embodiments are also disclosed, in which the coupler is designed in coplanar technology. In this case, the two coupling leads are in each case arranged with their two connection points on a common side of the substrate, wherein the coupling zones run parallel to one another with the smallest possible distance interval between them.

Finally, however, a directional coupler is also known from EP 1 014 472 B1, which in turn is likewise formed in suspended-substrate technology. This previously known directional coupler is a broadband directional coupler with at least two coupler sections connected in cascade, of different coupler loss, in which the coupler sections with loose coupling consist of face-coupled bus strips and the coupler sections with fixed coupling consist of broad-side-coupled bus strips.

In order to create the corresponding coupling zone with a fixed coupling, in this embodiment electroplated-through holes are provided in the substrate. All feed leads, however, are arranged on one side of the substrate.

With regard to the couplers previously known from the prior art, it can therefore be determined that these are frequently designed in microstrip conductor technology. As a result of the relatively high attenuation of the microstrip conduction and its sensitivity to fluctuations in the dielectric constants, the disadvantages of these couplers lie in the high space requirement and the relatively great electrical losses and the high costs of high-quality PCB material.

The disadvantages of the directional coupler in suspended-substrate technology are, on the one hand, high demands on the positioning of the substrate between the two earthing surfaces (problems arise here with the correct positioning in the horizontal but also with regard to the exact consideration of the distance intervals between the cover and the base). These requirements for correct or optimum positioning incur high costs for the mechanical processing and assembly. On the other hand, when a coupler is being designed the geometry of the housing is already determined as a result. This is often disadvantageous with regard to the possibility of reuse or the attainment of adequate flexibility with regard to the realisation and implementation of a selected concept for a coupler, as well as for its use for further applications.

In addition to this, from the electrical point of view, with this technology it is only possible with difficulty to compensate for the different phase velocities of the common-mode and differential-mode waves.

In the final analysis, the main disadvantages of directional couplers in coplanar technology lie in the minimum distance intervals required between the conductor paths coupled on the longitudinal side and the coupling factor which is also to this extent limited. In addition, the coupling factor is highly tolerance-dependent (etch tolerances and fluctuations in the dielectric constants of the substrate material exert a disadvantageous influence). A coupler in coplanar technology is also not optimum with regard to electrical losses.

A disadvantage with all three types of couplers, as explained heretofore, in particular with their use in a modern technical communications system, is that they do not have the properties of a high-frequency coupler required for this purpose, such as, for example, an adequate and suitable coupling factor, directional focus, or symmetry or cannot be produced or only with substantial development effort and expenditure.

From GB 2 218 853 A, a high-frequency coupler or power splitter is in addition known which comprises two coupling zones formed on one substrate on one side. Both coupling zones are provided in each case at the beginning and end with connection lines which lead to offset connections. Also, provided and formed between the two coupling zones are capacitors for the coupling of both coupling zones.

A directional coupler is also known from EP 1 014 472 B1. As a departure from the generic prior art, this directional coupler is formed on a substrate in such a way that the one coupling zone on the one substrate, and the second coupling zone coupled to it, is located on the opposite substrate side. In this situation, in each case a through connection through the substrate is provided on one side of the coupling zone, in order to create an electrical-galvanic connection of a connection line to an opposite coupling surface.

A microwave coupler is further known from U.S. Pat. No. 4,376,921, which likewise has four connections and two coupling zones, wherein, between the two coupling zones, which are kept comparatively short, capacitors are provided from the beginning to the end to provide coupling between the coupling zones.

Disadvantageous to all the coupler types referred to heretofore is that, in particular for use in a modern communications system, they do not have the necessary properties of a high-frequency coupler required for this, e.g. with a sufficient coupling factor, adequate directional focus, or symmetry, or cannot be produced or only with substantial development effort and expenditure. A generic coupler or power splitter has become known from US 2005/0017821 A1. Two connection lines are provided on the substrate, which lead to a beginning and an end of a first coupling zone. In addition, a second coupling zone, which is connected to the first coupling zone, is provided, two further connection lines leading to the beginning and end of the second coupling zone.

The two coupling zones referred to are formed on the substrate on two opposing sides, in which the entire arrangement with the lower coupling zone bears on a lower substrate.

Another coupler is known from US 2004/0113717 A1, which comprises, for example, earthed inter-digital capacitors which serve to improve the electrical properties.

The object of the technology herein is, therefore, taking the generic prior art as the starting point, to provide an improved coupler or power splitter, especially a narrow-band, preferably a 3 dB coupler, which is optimized in comparison with conventional solutions with regard to costs, construction size, losses and manufacturing tolerances.

The exemplary illustrative non-limiting HF coupler or power splitter has a series of positive advantages which set it apart from conventional solutions. The exemplary illustrative non-limiting high-frequency coupler is designed as narrow-band.

The coupling zone itself is formed on two opposite sides of a substrate, wherein at the two opposed ends of the coupling zone or at the two opposed ends in each case of one of the two coupling zones, an electroplated via hole is provided as in the prior art. As a result, it becomes possible, in the final effect, for all four external connection lines (even when one is closed off) to be arranged on one side of the substrate. This opens up the possibility that on one side on the substrate, should this become necessary, further electrical structural parts and components in conventional solder technology can be provided and connected.

In addition to this, the exemplary illustrative non-limiting coupler or power splitter has capacitors at the opposed end areas or connection areas to the individual coupling zones in each case, such as they are known in principle from EP 1 291 959 A1. As a departure from this, however, no discrete reactances or capacitors are used but instead what are referred to as inter-digital capacitors. These have not hitherto been used with such power splitters or couplers in this manner; inter-digital capacitors are in principle known from Rainee Simons Coplanar Waveguide Circuits, Components and Systems, first edition, New York, Chichester, Weinheim etc.; John Wiley & Sons, 2001. The use of such inter-digital capacitors in a coupler is, as a basic principle, known from the abovementioned US 2004/0113717 A1.

By way of an exemplary illustrative non-limiting solution, a power splitter or coupler can be produced with extremely low space requirement, of which the electrical parameters are within broad limits comparatively freely adjustable or pre-selectable. In particular, it has low electrical losses. In addition to this, the exemplary illustrative non-limiting power splitter or coupler is also characterized by its high directional focus. It is above all characterized by the fact that the exemplary illustrative non-limiting coupler or power splitter—which is generally built into a housing—also has a distance interval from the housing in the region of the lower coupling zone, i.e., a housing wall, thus no fixed dielectric is provided immediately adjacent and a lower ∈ is realized and attained which has a positive effect on the electrical properties of the coupler or power splitter. As a result, the exemplary coupler or power splitter has further advantages compared to the generic prior art.

The exemplary illustrative non-limiting coupler or power splitter is also comparatively robust in respect of housing tolerances. This is shown in particular in the selection of different cover distance intervals. This robustness in respect of housing tolerances also opens the possibility of individual designs being re-used in further application situations. In addition to this, the exemplary coupler is also comparatively robust with regard to etching tolerances as well as towards fluctuations in the dielectric constants of the substrate material. Further, in principle no further wiring arrangements or concentrated component elements are necessary, although basically they can be used if required. Finally, all feed lines are provided on the same side of the substrate, which is to be regarded as advantageous.

### BRIEF DESCRIPTION OF THE DRAWINGS

These and other features and advantages will be better and more completely understood by referring to the following detailed description of exemplary non-limiting illustrative implementations in conjunction with the drawings of which:

FIG. 1 is a schematic plan view of an exemplary illustrative non-limiting coupler;

FIG. 2 is a rear view of the exemplary illustrative non-limiting coupler;

FIG. 3 is a section along the line III-III in FIG. 1;

FIG. 4 is a representation corresponding to FIG. 1 in respect of an exemplary illustrative non-limiting implementation slightly modified in relation to FIG. 1; and

FIG. 5 is a rearwards view of the exemplary illustrative non-limiting implementation according to FIG. 4.

### DETAILED DESCRIPTION

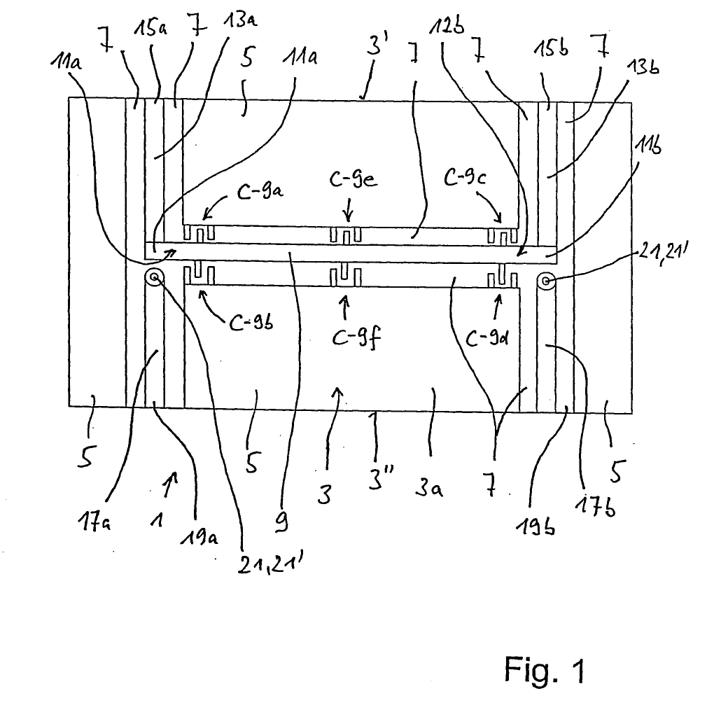

FIG. 1 shows a plan view of a first exemplary illustrative non-limiting coupler or power splitter 1 which is formed on a substrate 3 in the form of a printed circuit board.

Visible on the substrate 3 are four surface areas 5, on the upper side 3a of the substrate visible in FIG. 1, which are electrically-galvanically separated from one another by cut-outs 7. This surface area 5 involves earthing surfaces 5.

Formed in the cut-outs 7 is a first coupling zone 9 in stripline technology, which runs in a first direction or longitudinal direction on the substrate 3.

Provided at the beginning 11a and end 11b of this coupling zone 9, running transversely, are a first and second connection line 13a and 13b, which lead to connections 15a and 15b on the one substrate edge 3′.

The non-conductive cut-out area 7 shown in the plan view of the exemplary illustrative non-limiting implementation according to FIG. 1 is formed as H-shaped. In the immediate extension of the connection line 13a and 13b, however, separated from these, two further connection lines 17a and 17b are to be seen, which lead to the opposite substrate edge 3″ and there form connections 19a and 19b.

At the ends of the connection lines 17a, 17b opposite the connections 19a and 19b, these are provided with electroplated via holes 21, adjacent to the first coupling zone 9, which run through holes 21′ through the substrate 3.

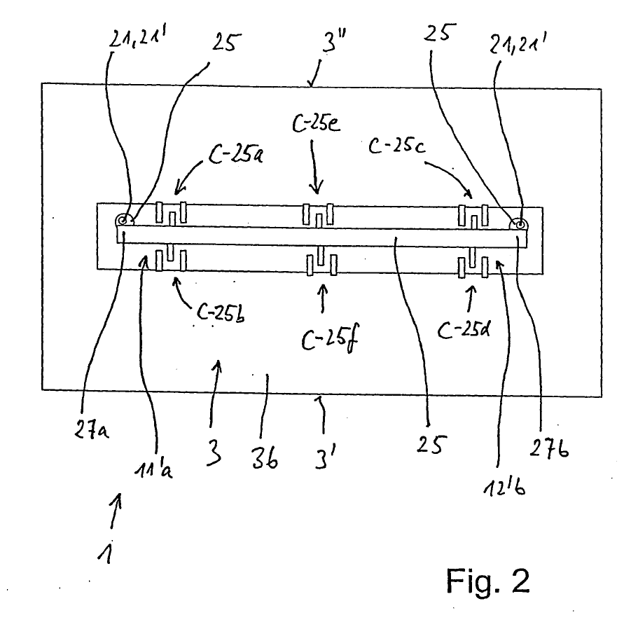

As can be seen in particular from the view from below from FIG. 2, a second coupling zone 25 is provided on the underside 3b reproduced there, which runs parallel to the first coupling zone 9, and in plan view, preferably, overlaps this in whole or at least in part. The length and/or width of the two coupling zones is also at least approximately the same in the exemplary implementation shown.

As can be seen from the view from below of the underside 3b of the substrate 3 according to FIG. 2, at the beginning 27a and at the end 27b of the second coupling zone 25, and corresponding to the second coupling zone, there are provided two electrically connected line extensions 25, formed in stripline technology, in the middle of which the holes 21′ of the electroplated via hole 21 end. Due to this, the second connection lines 17a and 17b are electrically-galvanically connected by way of the two electroplated via holes mentioned to the second coupling zone 25.

The length of the coupling zones corresponds to approximately lambda/4. The four feed or connection lines 13a, 13b and 17a, 17b are designed in coplanar conductor technology and connect the coupler 1 with other high-frequency modules not shown individually in this embodiment.

To improve the electrical properties, in the embodiment shown there are provided in addition a total of twelve capacitors C, which are located in each case in the input and output areas, i.e. at the beginning 11a and at the end 12b in each case of the first coupling zone 9, or at the beginning 11′a and at the end 12′b of the second coupling zone 25 respectively. In this situation, therefore, the capacitors C-9a and C-9b are arranged at one end of the first coupling zone 9 and the corresponding capacitors C-9c and C-9d at the other end. Corresponding capacitors are also provided at the beginning and end of the second coupling zone 25, namely the capacitors C-25a and C-25b, as well as, at the opposite end of the coupling zone 25, the capacitors C-25c and C-25d. These capacitors are not formed by the use of discrete components but in the form of inter-digital capacitors.

From FIGS. 1 and 2, however, it can be seen that in the exemplary illustrative non-limiting implementation shown, preferably provision is also made in the middle area, i.e. at half the length of the individual coupling zones 9 and 25 respectively, for a further pair of capacitors C, which in the embodiment shown is designated as C-9e and C-9f and C-25e and C-25f.

With regard to the capacitors, in each case the one capacitor surface or capacitor half is conductively connected to the individual coupling zones 9 and 25 respectively and the electrically-galvanically separated capacitor surface or capacitor half interacting with these, is connected to the pertinent earthing surface.

For this purpose, the substrate 3 is also provided on the underside according to FIG. 2 with a circumferentially enclosed earthing surface 31, in the middle area of which a non-conductive cut-out 33 is provided, within the longitudinal direction of which runs the second coupling zone 2, galvanically separated from the cut-out 33.

The dimensioning of the inter-digital capacitors can be effected in such a way that specific coupling properties can be adjusted or preselected by means of this. The earthing surfaces referred to are necessary, however, in order to provide, on the one hand, defined earthing conditions and, on the other, to form an earth potential for the inter-digital capacitors. The actual coupling accordingly takes place by way of the lines 9 and 25 formed on both sides of the substrate 3 (suspended substrate).

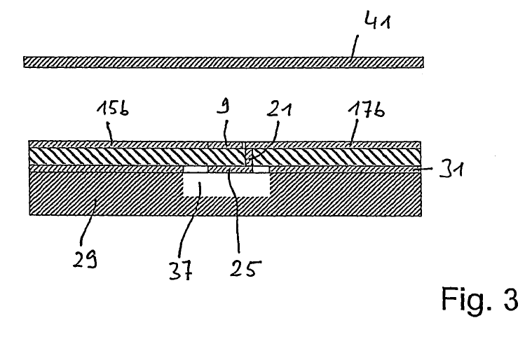

As can be seen from the cross-sectional representation according to FIG. 3, preferably an indentation 37 in a housing 29 is formed below the coupling zone, that is, a distance interval 37 from a corresponding housing wall 29 is provided. The dimension of the indentation, that is, the dimension of the distance interval between the substrate and the housing and housing wall 29 respectively, as well as the distance interval between the substrate and the cover 41 pertaining to it can be freely selected within certain limits.

Departing from the exemplary implementation shown, it is also possible for the capacitors provided preferably in the center of the coupling zones to be provided, instead of in the center, between the condensers at the beginning and end of the individual coupling zone. If appropriate, it is also possible for further additional capacitors to be provided between the capacitors located at the beginning and end areas of the individual coupling zone, i.e. more than in the exemplary implementations shown.

Related to the entire coupling length from the beginning area 11a to 12b, and from the beginning area 11′ a to the end area 12′b, the capacitors C-9a, C-9b and C-9c, C-9d respectively on the input and output sides, and on the opposite side the capacitors C-25a, C-25b and C-25c, C-25d respectively, can also be offset towards the center. The distance interval between the beginning and end areas can in this situation be, for example, up to 30% of the total length of the coupling zone, but preferably is less, in particular less than 25%, 20%, 15% or 10% respectively of the total length of the coupling zone. In this situation, account must be taken of the fact that the positioning of the capacitors at the beginning and end of the coupler develop the greatest effect.

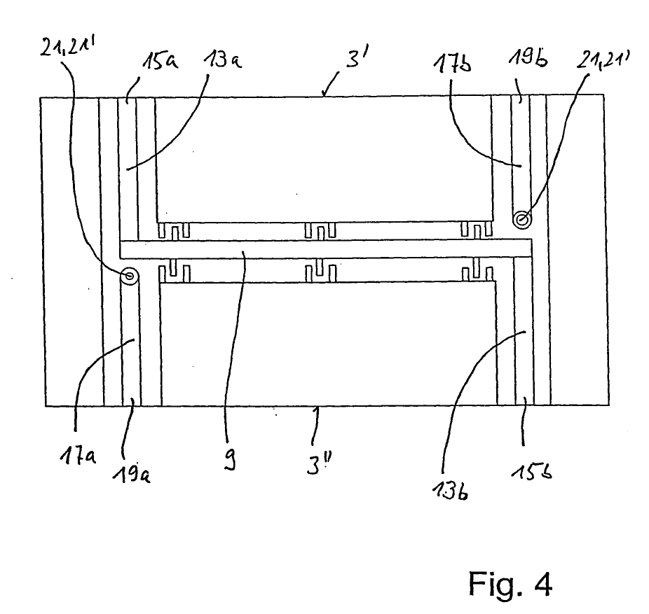

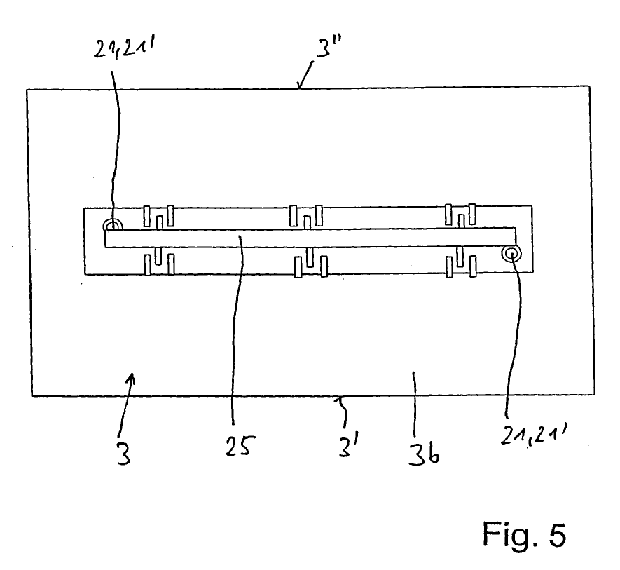

The exemplary illustrative non-limiting implementation according to FIGS. 4 and 5 corresponds largely to that according to FIGS. 1 to 3.

The only difference is that, for example, in the plan view of the substrate, in a manner comparable to the embodiment according to FIG. 1, the coupling zone 9 located on the one side of the substrate is not provided with two connection lines leading to the same peripheral boundary 3′ of the substrate but the connection line 15b, located on the right in FIG. 4, which is electrically-galvanically connected to the coupling zone 9, leads to the opposite side 3″ of the substrate, to the connection 17b formed there. Correspondingly, the right-hand connection line 17b, located at the top in FIG. 4, is provided with an electroplated via hole 21, so that the connection 19b located at the top right in FIG. 4 is electrically-galvanically connected to the connection 19a located in the bottom left in FIG. 4.

It therefore follows from the exemplary implementations explained that the earthing surfaces on both sides of the substrate in the area of the connection lines, as well as of the coupling zones 9 and 25, have cut-outs 7. The distance interval between the coupling paths 9 and 25 and the earthing surfaces amounts preferably to 1.5 to 4 times the width of the line. Likewise, the distance between the connection lines and the adjacent earthing surfaces amounts to about 1.5 to 4 times the width of these connection lines.

As has likewise been mentioned, the coplanar coupling lines 9 and 25 are arranged in a suitable manner for attaining the desired coupling. In a plan view of the substrate, i.e. perpendicular to the substrate plane, both coupling lines 9, 25, should therefore either lie above one another or have a lateral offset, which preferably is less than the width of the coupling line. Accordingly, the coupling lines in a plan view do not lie next to one another but overlap. Preferably, the lateral offset is greater than half the width of the coupling conductoripath 9 and 25 respectively, so that both lines, with the preferred width, overlap by fifty percent. In other words, the coverage should preferably be more than 0%, in particular more than 10%, more than 20%, more than 30% and preferably more than 50%, in particular related to the width of the coupling paths 9 and 25.

From the structure of the coupler or the power splitter described, it follows that the four connection lines 13a, 13b, and 17a, 17b, are formed in coplanar technology. It likewise results from the description of the embodiments of the invention that the two coupling zones 9 and 25 are formed in suspended-substrate technology.

While the technology herein has been described in connection with exemplary illustrative non-limiting implementations, the invention is not to be limited by the disclosure. The invention is intended to be defined by the claims and to cover all corresponding and equivalent arrangements whether or not specifically disclosed herein.

1. An HF-coupler or HF-power splitter, comprising:
A substrate, having two first connection lines, which lead to a beginning and an end of a first coupling zone,
A second coupling zone, coupled to the first coupling zone, to the beginning and end of which two further connection lines lead,
The four connection lines lead from the individual coupling zone in each case to connections located offset to one another,
The four connection lines being arranged on the same side of the substrate,
Provided in the longitudinal direction of the two coupling zones are offset-located capacitors (C), preferably at the individual beginning area and preferably at the individual end area respectively of the two coupling zones,
The two coupling zones being formed on the substrate on two opposing sides,
The two connection lines being electrically-galvanically connected to the first coupling zone and are arranged on the same side of the substrate as the first coupling zone, and
The second coupling zone being electrically-galvanically connected in its beginning and end areas in each case by means of an electroplated via hole to the connection lines belonging to it, which lie on the side of the substrate opposite the coupling zone,
The area of the second coupling zone, a distance interval is provided from a housing wall,
The capacitors (C) located offset in the longitudinal direction of the two coupling zones, preferably the capacitors provided at the beginning as well as at the individual end of the individual coupling zone being in each case formed as inter-digital capacitors and
The capacitors being in each case coupled to earth.

2. The coupler or power splitter, in particular the HF-coupler or HF-power splitter or coupler as claimed in claim 1, wherein, at least with regard to one coupling zone and preferably with regard to both coupling zones, at least one further capacitor is provided in each case between the beginning and end areas respectively.

3. The coupler or power splitter as claimed in claim 2, wherein the additional capacitors provided are arranged in the middle area of the individual coupling zone.

4. The coupler or power splitter as claimed in claim 1, wherein the one coupling zone with the connection lines belonging to it is arranged in plan view in such a way that the connection lines, related to the coupling zone, lead to the same substrate edge and preferably in plan view form at least approximately a U-shaped conductor path.

5. The coupler or power splitter as claimed in claim 1, wherein also the connection line connected electrically-galvanically by the electroplated via hole to the second coupling zone is arranged in plan view in such a way that the connection lines related to the coupling zone lead to the same substrate edge and preferably in plan view form approximately a U-shaped conductor path.

6. The coupler or power splitter as claimed in claim 4, wherein the connection line connected to the one coupling zone leads to the one substrate edge, while by contrast the connection line connected electrically-galvanically to the second coupling zone leads to the opposite substrate edge.

7. The coupler or power splitter as claimed in claim 1, wherein the one coupling zone with the connection lines belonging to it is arranged in such a way in plan view that the one connection line, related to the coupling zone leads with at least one component in a direction away from the coupling zone, preferably to a substrate edge, while by contrast the second connection line with a component pointing in an opposite direction leads away from the coupling zone, preferably to the opposite substrate edge.

8. The coupler or power splitter as claimed in claim 6, wherein the two connection lines connected to the coupling zone at the beginning and the end with the opposed component lead preferably in the opposed direction from the coupling zone, so that, preferably, in the plan view a conductor path is formed which is at least approximately Z-shaped.

9. The coupler or power splitter as claimed in claim 6, wherein also the connection lines, electrically-galvanically connected to the opposite coupling zone by the electroplated via hole lead away at the beginning and at the end of this coupling zone, with opposed components and preferably in the opposed direction from the coupling zone, so that, preferably, in plan view a conductor path is formed which is at least approximately Z-shaped.

10. The coupler or power splitter as claimed in claim 1, wherein, in the area of the coupling zone and/or in the area of the connection lines, the earthing surfaces formed on the upperside or underside of the substrate have cut-outs, in which the connection lines and the coupling zones are arranged.

11. The coupler or power splitter as claimed in claim 10, wherein the distance interval between the coupling zones and/or the connection lines and the earthing surfaces corresponds to between 1.5 to 4 times the width of the coupling zone and the width of the connection lines.

12. The coupler or power splitter as claimed in claim 1, wherein the coupling zones in plan view perpendicular to the surface of the substrate overlap and the overlap area related to the width of the two coupling zones amounts to at least 10%, preferably more than 40%, or, in particular, more than 70%.

13. The coupler or power splitter as claimed in claim 1, wherein the four connection lines are designed in coplanar technology.

14. The coupler or power splitter as claimed in claim 1, wherein the two coupling zones are designed in suspended-substrate technology.

15. The coupler or power splitter as claimed in claim 1, wherein the distance interval or the indentation beneath the coupling area of the second coupling zone is formed in a housing.
